(19) United States
(12) Patent Application Publication
(10) Pub. No.: US 2007/0149720 A1
(43) Pub. Date: Jun. 28, 2007

(54) Novel polymers

(76) Inventors: Keith Davis, Kinver (GB); Gary Woodward, Northwich (GB); Julie Hardy, Dudley (GB); Kim Carmichael, Whoberley (GB); Graham Otter, Catshill (GB)

Correspondence Address: Jean Louis Seugnet;Rhodia Inc, 8 Cedar Brook Drive, Cranbury, NJ, 08512-7500, US

(21) Appl. No.: 10/568,852

(22) PCT Filed: Sep. 2, 2004
(86) PCT No.: PCT/GB04/03730

§ 371 Date: Dec. 4, 2006

(30) Foreign Application Priority Data
Sep. 2, 2003 (GB) 0320496.3

(51) Int. Cl. C08L 77/00

(52) U.S. Cl. 525/432

(57) ABSTRACT

A polymer of formula (I) wherein: R and R′ are each independently selected from hydrogen, a hydroxyl group, a carboxyl group, an alkyl, aryl or alkaryl group or a hydroxy—or carboxy substituted—alkyl, aryl or alkaryl group provided that R and R′ together have a total of less than 23 carbon atoms and n is greater than 1; X is hydrogen or a cation or an alkyl group; one of R², R³, R⁴, R⁵ is a phosphonate or a sulphonate group and the remainder of R², R³, R⁴, R⁵ are each independently selected from hydrogen, alkyl, aryl, alkaryl, alkoxy, hydroxy, hydroxy or carboxy substituted alkyl, phosphonate or sulphonate groups and a is from 1 to 5; R⁶, R⁷, R⁸, R⁹ are each independently selected from hydrogen, alkyl, aryl, alkaryl, hydroxy, alkoxy, hydroxy or carboxy substituted alkyl or carboxy groups and b is from 5 to 200. The polymer has uses in the fields of water treatment and corrosion inhibition.

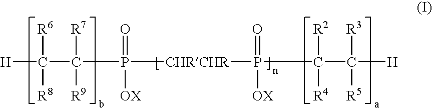

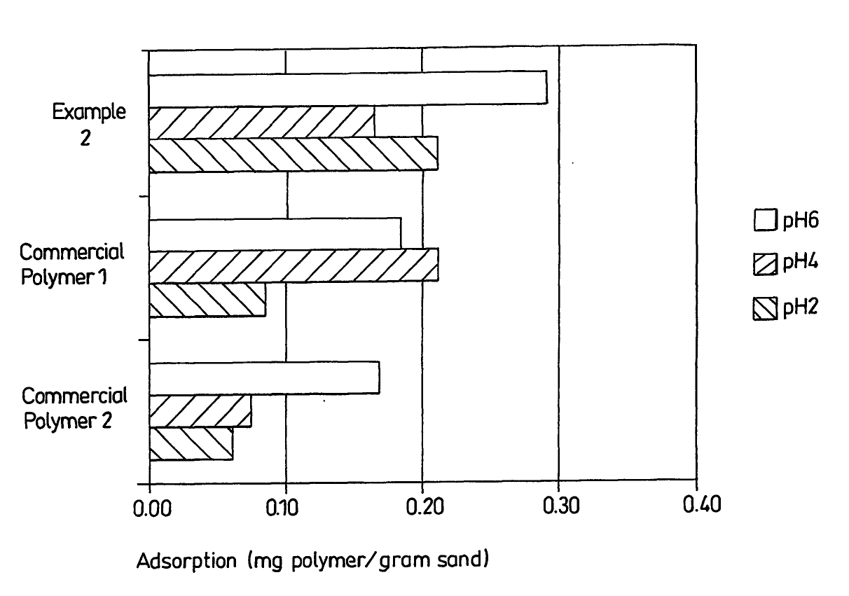

This invention relates to novel polymers, to a method of making said polymers and to the use of said polymers.

Accordingly, the present invention provides a polymer of formula (I) 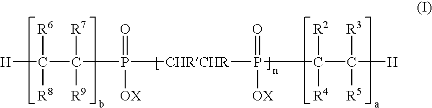
wherein
R and R′ are each independently selected from hydrogen, a hydroxyl group, a carboxyl group, an alkyl, aryl or alkaryl group or a hydroxy—or carboxy substituted—alkyl, aryl or alkaryl group, provided that R and R′ together have a total of less than 23 carbon atoms and n is greater than 1;
X is hydrogen or a cation or an alkyl group;
one of R², R³, R⁴, R⁵ is a phosphonate group or a sulphonate group and the remainder of R², R³, R⁴, R⁵ are each independently selected from hydrogen, alkyl, aryl, alkaryl, alkoxy, hydroxy, hydroxy or carboxy substituted alkyl, phosphonate or sulphonate groups and a is from 1 to 5;
R⁶, R⁷, R⁸, R⁹ are each independently selected from hydrogen, alkyl, aryl, alkaryl, hydroxy, alkoxy, hydroxy or carboxy substituted alkyl or carboxy groups and b is from 5 to 200.

Further provided is a polymer of formula (V) 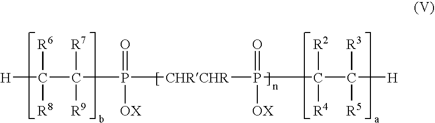
wherein:
R and R′ are each independently selected from hydrogen, a hydroxyl group, a carboxyl group, an alkyl, aryl or alkaryl group or a hydroxy—or carboxy substituted—alkyl, aryl or alkaryl group provided that R and R′ together have a total of less than 23 carbon atoms and n is greater than 1;
X is hydrogen or a cation or an alkyl group;
R², R³, R⁴, R⁵ are each independently selected from hydrogen, alkyl, aryl, alkaryl, alkoxy, hydroxy, hydroxy or carboxy substituted alkyl, phosphonate or sulphonate groups and a is from 1 to 5;
R⁶, R⁷, R⁸, R⁹ are each independently selected from hydrogen, alkyl, aryl, alkaryl, hydroxy, alkoxy, hydroxy or carboxy substituted alkyl, sulphonate or carboxy groups and b is from 5 to 200.

The present invention further provides a method of making the polymer of formula (I) or formula (V), the method comprising reacting;
1) a compound of Formula (II) 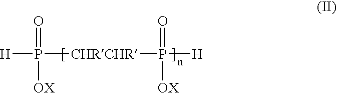
   wherein R, R′, n and X each have the same significance as in Formula (I) or (V) respectively;
with 2) a monomer of Formula (III) 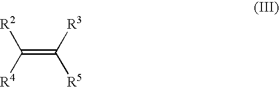
   in the presence of an initiator; and subsequently reacting the reaction product of 1) and 2) with a further monomer of Formula (IV): 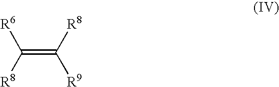
   wherein R¹, R³, R⁴, R⁵, R⁶, R⁷, R⁸ and R⁹ each have the same significance as in Formula (I) and (V) respectively.

The monomer (III) is preferably selected from the group consisting of vinyl phosphonic acid (VPA), vinylidene-1,1-diphosphonic acid (VDPA) and vinyl sulphonic acid (VSA).

The initiator is preferably sodium persulphate (Na₂S₂O₈). Alternatively, the initiator may be hydrogen peroxide, an azo compound such as azo-bis-isobutyronitrile, an organic peroxide or a source of ultraviolet or ionising radiation.

The monomer (IV) is preferably an unsaturated carboxylic acid such as acrylic acid. Alternatively, other monocarboxylic or dicarboxylic unsaturated acids (such as methacrylic acid, fumaric acid, maleic acid, itaconic acid, aconitic acid, mesaconic acid, citraconic acid, crotonic acid, isocrotonic acid, angelic acid, tiglic acid and their water soluble salts) may be used.

The reaction may be carried out at a temperature of between 60° C. and 110° C. Preferably, the reaction is carried out at a temperature of about 95° C.

Polymers made according to the present invention may be used for the inhibition of scale in aqueous systems, for example boilers, cooling systems, desalination plants, geothermal waters and oilfield brines.

Polymers made according to the present invention may suitably be used in aqueous-based functional fluids such as hydraulic fluids, lubricants, cutting fluids and oilfield drilling muds.

In particular, polymers of the present invention may be used in the squeeze treatment of oil wells. They are especially effective in inhibiting the formation of barium sulphate scale and/or calcium carbonate scale in oilfields. For example, in oil wells, the hole is typically flushed out with an aqueous surfactant to provide a water-wettable surface and then impregnated with a solution of the inhibitor. Calcium salts are then formed in situ, either by calcium in the formation (where the latter comprises limestone) or by prior, or subsequent, treatment of the hole with an aqueous solution of a calcium salt, (where the formation comprises sandstone).

Effective concentrations may typically range from 1 to 200 ppm. For instance, 1.5 to 20 ppm, most preferably 2 to 10 ppm, may give useful corrosion protection. However, for oilfield scale prevention where barium sulphate is a problem, concentrations in the range 5 to 200 ppm, especially 8 to 25 ppm, e.g. 10 to 20 ppm, are preferred.

Polymers according to the present invention may be used in combination with one another, and/or in conjunction with other water treatment agents including: surfactants, such as anionic surfactants (e.g. C₁₀₋₂₀ alkyl benzene sulphonates, C₁₀₋₂₀ olefin sulphonates, C₁₀₋₂₀ alkyl sulphates, C₁₀₋₂₀ alkyl 1 to 25 mole ether sulphates, C₁₀₋₂₀ paraffin sulphonates, C₁₀₋₂₀ soaps, C₁₀₋₂₀ alkyl phenol sulphates, sulphosuccinates, sulphosuccinamates, lignin sulphonates, fatty ester sulphonates, C₁₀₋₂₀ alkyl phenol ether sulphates, C₁₀₋₂₀ alkyl ethanolamide sulphates, C₁₀₋₂₀ alpha sulphofatty acid salts, C₁₀₋₂₀ acyl sarcosinates, isethionates, C₁₀₋₂₀ acyl taurides, C₁₀₋₂₀ alkyl hydrogen phosphates), non-ionic surfactants (e.g. ethoxylated natural or synthetic C₈₋₂₅ alcohols, ethoxylated fatty acids, ethoxy/propyleneoxy block copolymers, ethoxylated fatty amines, mono- and di-alkanolamides, amine oxides and C₁₀₋₂₀ acyl sorbitan and/or glyceryl ethoxylates) amphoteric surfactants (e.g. betaines, sulphobetaines, and/or quaternised imidazoline), and/or cationic surfactants (e.g. benzalkonium salts, C₁₀₋₂₀ alkyl trimethyl ammonium salts, and/or C₁₀₋₂₀ alkyl trimethyl or tris (hydroxymethyl) phosphonium salts); sequestrants, chelating agents, corrosion inhibitors and/or other threshold agents (e.g. sodium tripolyphosphate, sodium ethylenediamine tetraacetate, sodium nitrilo triacetate, tetra potassium pyrophosphate, acetodiphosphonic acid and its salts, ammonium trismethylene phosphonic acid and its salts, ethylenediamine tetrakis (methylene phosphonic) acid and its salts, diethylenetriamine pentakis (methylene phosphonic) acid, hexamethylenediamine tetrakis (methylene phosphonic) acid, bishexamethylenetriamine pentakis (methylene phosphonic) acid and ethanolamine bis(methylenephosphonic) acid and its salts); tolyltriazole and mixtures of nitrate, benzoate, HHP and/or PTCB) biocides (e.g. tetrakis (hydroxymethyl) phosphonium salts, formaldehyde, glutaraldehyde); oxidising biocides and/or bleaches (e.g. chlorine, chlorine dioxide, hydrogen peroxide, sodium perborate); foam controlling agents such as silicone antifoams, acetylenic diols; oxygen scavengers such as hydrazines and/or hydroxylamines; pH controlling and/or buffering agents such as amines, borates, citrates and/or acetates; chromium salts; zinc salts; and/or other water treatment agents such as polymeric dispersants and coagulants including polymaleic, polyacrylic. and polyvinylsulphonic acids and their salts, starches and/or carboxy methyl cellulose and/or molybdates. The invention provides formulations comprising an effective amount of a product of the invention as aforesaid and any of the aforesaid known water treatment agents. Such formulations may, for example, contain from 5 to 95% by weight of a product according to the present invention and from 5 to 90% by weight of one or more of any of the aforesaid water treatment agents.

According to a further embodiment, the present invention provides a corrosion-inhibiting pigment which is a solid composition prepared by reacting a concentrated aqueous solution of a water-soluble polymer or telomer according to the invention with a base or a salt of calcium, zinc, barium, aluminium or other polyvalent metal and precipitating a solid salt.

According to a still further embodiment, our invention provides a corrosion-inhibiting coating composition containing a pigment as described in the immediately-preceding paragraph.

The corrosion-inhibiting pigment may be dissolved or dispersed in a paint, varnish, enamel, lacquer, or other coating formulation to form the corrosion-inhibiting coating composition. The formulation may further comprise a liquid vehicle such as water, or a volatile organic solvent including petroleum spirit, turpentine, ketones, esters and/or aromatic hydrocarbon solvent, and/or a drying oil, such as linseed oil, soya oil, tung oil or dehydrogenated castor oil, which can be dissolved in said volatile organic solvent or emulsified in said water.

The formulation may typically also comprise a resin, e.g. a polyester, urea formaldehyde, melamine, acrylic, alkyd, polyurethane, vinyl chloride, vinyl acetate, phenolic or epoxy resin, dissolved or dispersed therein, and/or a dispersed pigment. We prefer that the pigment should be or should comprise other corrosion-inhibiting pigments such as red lead, potassium zinc chromate, metallic zinc or aluminium powder or zinc oxide and/or that the formulation should contain one or more of the other corrosion inhibitors referred to hereinabove, in addition to the corrosion-inhibiting pigment of the invention.

The coating compositions may additionally contain any of the conventional paint ingredients, including pigments such as titanium oxide, iron oxide, carbon black, phthaldcyanine pigments or aluminium stearate, chlorinated rubber, polystyrene, silicone, asphalt, wetting agents, dispersants, emulsifiers, biocides, flocculants, marine antifoulants, antifoams, viscosifiers, fire retardants, fluorescers, aerosol propellants, talc, clay and/or plasticisers.

Alternatively, the water soluble corrosion-inhibiting pigments of the invention may be used to provide a corrosion-inhibiting treatment for metal surfaces such as steel, aluminium and aluminium alloys after machining and prior to storage, coating, electroplating, polishing or etching. Typically the work is coated with an aqueous solution containing at least an operative amount of said corrosion-inhibiting pigment, e.g., 10 to 500 ppm, preferably 25 to 300 ppm, such as 20 to 200 ppm, especially 25 to 100 ppm, more especially 30 to 80 ppm.

After contacting with the corrosion-inhibiting solution, the work may be rinsed and/or subjected to one or more coating or finishing operations such as resin coating, lacquering, enamelling, painting, electrophoretic coating, spattering, vapour deposition, electrodeposition, etching, chemical or electrical polishing or may be put aside for storage.

The work may be greased for storage, but an advantage of treatment with a corrosion-inhibiting pigment of the present invention is that greasing and hence subsequent degreasing can be avoided.

The polymer of the present invention may be incorporated into solid or liquid detergent compositions. It functions as a stain remover and also may help to stabilise any bleach present. It exhibits valuable detergent-building action by sequestering calcium. Typically it is added to detergent compositions in amounts of from 0.5 to 20% by weight of the composition.

The liquid detergent composition preferably contains 5 to 50%, e.g. 10 to 40% by weight surfactant, 5 to 60%, e.g. 10 to 40% builder, 20 to 75%, e.g. 50 to 70% by weight water and 0.1 to 25% by weight of said polymer. The liquid detergent composition preferably also contains conventional amounts of minor adjuncts including enzymes, soil suspenders such as sodium carboxymethyl cellulose, optical brighteners, dyes, perfumes, preservatives and foam modifiers.

The builder preferably comprises non-phosphate builders such as zeolite, carbonate, citrate, nitrilotriacetate and ethylene diamine tetracetate.

The solid detergent composition may contain from 1 to 90% by weight of surfactant, more usually 2 to 70%, e.g. 3 to 60% especially 4 to 50%, preferably 5 to 40%, more preferably 6 to 30%, most preferably 7 to 20% by weight of surfactant.

For example the surfactant may be, or may comprise, one or more anionic surfactants such as an alkyl benzene sulphate, alkyl sulphate, alkyl ether sulphate, paraffin sulphonate, olefin sulphonate, alkyl ether sulphonate, alkylphenyl sulphate, alkylphenyl ether sulphate, alkyl sulphosuccinate, alkyl sulphosuccinamate, alkyl isethionate, alkyl sarcosinate, soap, alkyl ether carboxylate, alkyl ether polycarboxylate, alkyl tauride, alkyl phosphate, alkyl ether phosphate or alkyl- or thiol-capped polyelectrolytes such as an alkylthiol-capped polymaleic acid.

All references to “alkyl” groups in the immediately-preceding paragraph refer to C₈₋₂₂ straight or branched chain alkyl or alkenyl groups. “Ether” refers to glyceryl, to mono- or poly-ethylenoxy, or to mono- or poly-propyleneoxy. The cation of the aforesaid anionic surfactants is usually sodium, but may be potassium or mono-, di- or tri-alkylolamine. Less commonly, the cation may be lithium, ammonium, calcium, magnesium, zinc or a mono-, di- or tri-alkyl amine such as isopropylamine or trimethylamine.

The surfactant may also be, or may comprise, one or more non-ionic surfactants such as the polyalkoxylated derivatives of alcohols, carboxylic acids, alkyl phenols, alkylamines, alkanolamides, or glycerol or sorbitan ester, wherein each compound has an “alkyl” group as hereinabove defined, and the polyalkyleneoxy group comprises from 1 to 50, e.g. 2 to 10, ethyleneoxy groups.

The present invention will be illustrated by way of the following examples.

### EXAMPLE 1

A phosphorus-based oligomer was prepared as described in EP 1254144. This oligomer is believed to have the structure of formula (II).

### EXAMPLE 2

VPA (0.109 moles) was added to 28.8 g of the product from Example 1 in a round-bottomed flask, fitted with a temperature probe and a reflux condenser. The mixture was heated to 85° C. Sodium persulphate (0.0054 moles) was added in water (5 mls) over 45 minutes, followed by a 30-minute age, to produce a viscous liquid, characterised by ³¹P NMR.

### EXAMPLE 3

The viscous liquid of example 2 (0.0112 moles) was adjusted to pH 4.5 with sodium hydroxide (48% w/w, 0.08 moles), diluted with water (30 g), and placed in a round-bottomed flask fitted with a reflux condenser and a temperature probe. The solution was heated to 60-110° C. (preferably 85° C.). Acrylic acid (0.224 moles) was adjusted to pH 4.5 with sodium hydroxide (48% w/w, 0.157 moles) and then diluted with water (114 g). This solution and sodium persulphate (0.0112 moles) in water (18g) were added concurrently using peristaltic pumps over 4 hours, followed by a 30-minute age.

The product was analysed by isocratic GPC system with RI detection. Calculation of molecular weights employs a narrow standard calibration using poly(acrylic acid) calibrants of defined peak and weight averages Mₚ and M_{w} respectively). A molecular weight of 3823 g/mol was determined.

Test Conditions

Test Temperature

121° C., 5 Bar (500 kPa)

Test Medium—

A synthetic formation water (produced water) corresponding to a 50:50 mix of Formation Water:Sea Water having the following compositions:

| | IONIC COMPOSITION (mg/l) | | |
|---|---|---|---|
| ION | Formation water | Sea Water | Produced Water |
| Na⁺ | 24100 | 10890 | 17495 |
| K⁺ | 1180 | 460 | 820 |
| Ca²⁺ | 520 | 428 | 474 |
| Mg²⁺ | 73 | 1368 | 720 |
| Ba²⁺ | 650 | 0 | 325 |
| Sr²⁺ | 55 | 7 | 31 |
| Cl | 40400 | 19766 | 30083 |
| SO₄²⁻ | 10 | 2960 | 1485 |
| HCO₃⁻ | 0 | 140 | 70 |

Test pH—

The pH value of both waters is buffered to pH 4.90±0.05@25° C. by the inclusion of 0.01M. acetic acid/sodium acetate buffer.

Inhibitor Concentration—

The run starts with an initial inhibitor level of 160 mg/l (active acid) in the combined flow and decreases the concentration in 20 mg/l steps, with a complete tube cleaning and washing cycle being performed between each decrement.

Cycle Time—

Each level of inhibitor is evaluated for 30 minutes before proceeding to the next, i.e. lower, level. The pressure drop across the narrow bore coil is continuously monitored and logged by a personal computer running Advantech ‘Genie’ data acquisition and control software.

Fail Criterion & M.I.C.—

In the absence of inhibitor and under these conditions, the tube becomes rapidly blocked with scale. In practice, to prevent complete and irrecoverable blockage of the tube, the brine flows are terminated and tube cleaning commences when the pressure drop reaches 1 psia (6.89 kPa). When evaluating inhibitors, if the pressure drop exceeds 1 psia (6.89 kPa) within the 30 minutes cycle time, then the inhibitor is deemed to have failed at that level. The minimum inhibitory concentration, M.I.C., therefore obviously lies somewhere between the “fail level” and the previous concentration at which the tube remained essentially clear for 30 minutes.

Results

The polymer in accordance with the present invention was found to be superior in a scale inhibition test to the other products, as shown in Table 1 below.

TABLE 1
Scale inhibition test:

| | | Tube block test/ | Mw |
|---|---|---|---|
| Sample | Reaction | ppm failure | (g/mol) |
| Example 3 | P Block polymer, | 100, 100 | 3823 |
| | Acrylate and VPA | | |
| (i) Commercial | Standard sample | 100, 120, 120 | 3780 |
| Polymer 1 | | | |
| (ii) Commercial | Standard sample | 100, 120, 120 | 5500 |
| Polymer 2 | | | |

(i) a phosphonate end-capped poly(acrylic) acid.
(ii) a phosphonate end-capped copolymer of vinylsulphonic acid and acrylic acid.

Adsorption Onto Sandstone
Test Conditions

10 g of acid-washed crushed Clashach sandstone, with a particle size of 150-710 microns, was mixed with 20 ml of 500 mg/l polymer solution at the desired pH, placed in a tightly sealed bottle and heated in an oven at 95° C. for 20 hours. After this time the solution was filtered through a 0.45 micron membrane filter and analysed for polymer content by turbidimetric determination with ‘Hyamine 1622’. The initial polymer concentration was also determined and the amount of polymer lost by adsorption onto the sand calculated using the formula:

$$Adsorption ( mg \text{/} g ) = \frac{( {C}_{initial} - {C}_{final} ) \times {V}_{soln}}{{M}_{sand} 1000}$$

Results

The polymer according to the present invention was found to have superior adsorption properties when compared to other products.

This is illustrated in the accompanying Graph.

1-25. (canceled)

26. A polymer of formula (I) 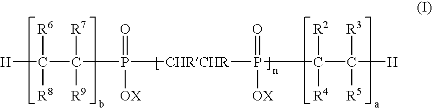
wherein:
R and R′ are each independently hydrogen, a hydroxyl group, a carboxyl group, an alkyl, aryl or alkaryl group or a hydroxy—or carboxy substituted—alkyl, aryl or alkaryl group provided that R and R′ together have a total of less than 23 carbon atoms and n is greater than 1;
X is hydrogen or a cation or an alkyl group;
one of R², R³, R⁴, R⁵ is a phosphonate or a sulphonate group and the remainder of R², R³, R⁴, R⁵ are each independently hydrogen, alkyl, aryl, alkaryl, alkoxy, hydroxy, hydroxy or carboxy substituted alkyl, phosphonate or sulphonate groups and a is from 1 to 5;
R⁶, R⁷, R⁸, R⁹ are each independently hydrogen, alkyl, aryl, alkaryl, hydroxy, alkoxy, hydroxy or carboxy substituted alkyl or carboxy groups and b is from 5 to 200.

27. A method of making the polymer as defined in claim 26, comprising the step of reacting;
1) a compound of Formula (II): 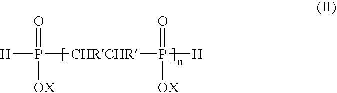
wherein R, R′, n and X each have the same significance as in Formula (I);
with 2) a monomer of Formula (III) 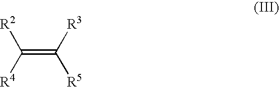
in the presence of an initiator; and subsequently reacting the reaction product of 1) and 2) with a further monomer of Formula (IV): 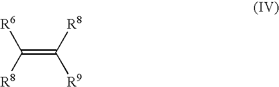
wherein R², R³, R⁴, R⁵, R⁶, R⁷, R⁸ and R⁹ each have the same significance as in Formula (I).

28. A method as claimed in claim 27 wherein the monomer (III) is selected from the group consisting of vinyl phosphonic acid (VPA), vinylidene-1,1-diphosphonic acid (VDPA) and vinyl sulphonic acid (VSA).

29. A method as claimed in claim 28 wherein the initiator is sodium persulphate (Na₂S₂O₈).

30. A method as claimed in claim 28 wherein the initiator is hydrogen peroxide, an azo compound, an organic peroxide or a source of ultraviolet or ionising radiation.

31. A method as claimed in claim 28 wherein the monomer (IV) is an unsaturated carboxylic acid.

32. A method as claimed in claim 31 wherein the monomer (IV) is acrylic acid, methacrylic acid, fumaric acid, maleic acid, itaconic acid, aconitic acid, mesaconic acid, citraconic acid, crotonic acid, isocrotonic acid, angelic acid, tiglic acid or their water soluble salts.

33. A method as claimed in claim 28 wherein the reaction is carried out at a temperature of between 60° C. to 110° C., optionally 95° C.

34. A method for the inhibition of scale in an aqueous system comprising the step of treating the system with a polymer as defined in claim 26.

35. The method as claimed in claim 34 wherein the aqueous based functional fluid is a boiler, a cooling system, a desalination plant, a geothermal water or an oilfield brine.

36. A method for the treatment of hydraulic fluids, lubricants, cutting fluids and oilfield drilling muds comprising the step of treating the system with a polymer as defined in claim 26.

37. A method for the squeeze treatment of oil wells comprising the step of treating the oil wells with a polymer as defined in claim 26.

38. A method for inhibiting the formation of barium sulphate scale and/or calcium sulphate scale of fluids in oilfields comprising the step of treating the fluids with a polymer as defined in claim 26.

39. A water treatment agent comprising a polymer as claimed in claim 26 in conjunction with one or more other water treatment agents selected from the group consisting of surfactants; sequestrants; chelating agents; corrosion inhibitors; oxidising biocides; bleaches; foam controlling agents; buffers and dispersants.

40. A corrosion-inhibiting pigment comprising a solid which has been prepared by reacting a concentrated aqueous solution of a water-soluble polymer as defined in claim 26 with a base or salt of calcium, zinc, barium, aluminium or other polyvalent metal and precipitating a solid salt.

41. A corrosion-inhibiting formulation comprising a pigment as claimed in claim 40 which is dissolved or dispersed in an anti-corrosive paint, varnish, enamel, or lacquer.

42. The corrosion-inhibiting formulation as claimed in claim 41 further comprising a liquid vehicle, optionally being water.

43. The corrosion-inhibiting formulation as claimed in claim 41 wherein the formulation further comprises a volatile organic solvent selected from the group consisting of petroleum spirit, turpentine, ketones and esters and/or an aromatic hydrocarbon solvent, or a drying oil selected from the group consisting of linseed oil, soya oil, tung oil, and dehydrogenated castor oil.

43. The corrosion-inhibiting formulation as claimed in claim 41 wherein the formulation further comprises a resin selected from the group consisting of polyester, urea, polyurethane, vinyl chloride, vinyl acetate, phenolic and epoxy resins or a dispersed pigment.
